(19) United States
(12) Patent Application Publication
(10) Pub. No.: US 2025/0314891 A1
(43) Pub. Date: Oct. 9, 2025

(54) PHOTONIC INTEGRATED CIRCUIT BASED LASER ENGINE FOR HIGH RESOLUTION AND CROSSTALK FREE AR DISPLAY AND EYE TRACKING

(71) Applicant: Meta Platforms Technologies, LLC, Menlo Park, CA (US)

(72) Inventor: Oguzhan AVCI, Bellevue, WA (US)

(21) Appl. No.: 19/052,796

(22) Filed: Feb. 13, 2025

Related U.S. Application Data
(60) Provisional application No. 63/573,745, filed on Apr. 3, 2024.

(51) Int. Cl. G02B 27/01

(52) U.S. Cl. CPC G02B 27/0172

(57) ABSTRACT

A light engine for near-eye display includes an array of color pixels. Each color pixel of the array of color pixels includes a first input waveguide, a second input waveguide, a third input waveguide, and an output waveguide in a waveguide layer; a first light emitter configured to emit light of a first color and optically coupled to the first input waveguide; a second light emitter configured to emit light of a second color and optically coupled to the second input waveguide; a third light emitter configured to emit light of a third color and optically coupled to the third input waveguide; and one or more waveguide couplers configured to couple light from the first input waveguide, the second input waveguide, and the third input waveguide into the output waveguide to combine into light of a desired color and brightness.

### CROSS-REFERENCE TO RELATED APPLICATIONS

This application claims the benefit of and priority to U.S. Provisional Application No. 63/573,745, filed Apr. 3, 2024, entitled “PHOTONIC INTEGRATED CIRCUIT BASED LASER ENGINE FOR HIGH RESOLUTION AND CROSSTALK FREE AR DISPLAY AND EYE TRACKING,” which is hereby incorporated by reference in its entirety for all purposes.

### BACKGROUND

An artificial reality system, such as a head-mounted display (HMD) or heads-up display (HUD) system, generally includes a near-eye display system in the form of a headset or a pair of glasses and configured to present content to a user via an electronic or optic display within, for example, about 10-20 mm in front of the user's eyes. The near-eye display system may display virtual objects or combine images of real objects with virtual objects, as in virtual reality (VR), augmented reality (AR), or mixed reality (MR) applications. A near-eye display generally includes an optical system configured to form an image of a computer-generated image on an image plane. The optical system of the near-eye display may relay the image generated by an image source (e.g., a display panel) to create a virtual image that appears to be away from the image source and further than just a few centimeters away from the user's eyes.

### SUMMARY

This disclosure relates generally to near-eye display. More specifically, and without limitation, techniques disclosed herein relate to light beam scanning-based near-eye display. Various inventive embodiments are described herein, including devices, systems, methods, structures, materials, processes, and the like.

According to certain embodiments, a light engine for near-eye display may include a first substrate, a waveguide layer on the first substrate, and a plurality of light emitters optically coupled to the first substrate. The waveguide layer includes a plurality of input waveguides and a plurality of output waveguides, where each group of three input waveguides of the plurality of input waveguides are coupled to a respective output waveguide of the plurality of output waveguides. The plurality of light emitters include a first set of light emitters configured to emit light of a first color, a second set of light emitters configured to emit light of a second color, and a third set of light emitters configured to emit light of a third color. A first light emitter of the first set of light emitters is optically coupled to a first input waveguide of a group of three input waveguides, a second light emitter of the second set of light emitters is optically coupled to a second input waveguide of the group of three input waveguides, and a third light emitter of the third set of light emitters is optically coupled to a third input waveguide of the group of three input waveguides.

According to certain embodiments, a light engine for near-eye display includes an array of color pixels. Each color pixel of the array of color pixels includes a first input waveguide, a second input waveguide, a third input waveguide, and an output waveguide in a waveguide layer; a first light emitter configured to emit light of a first color and optically coupled to the first input waveguide; a second light emitter configured to emit light of a second color and optically coupled to the second input waveguide; a third light emitter configured to emit light of a third color and optically coupled to the third input waveguide; and one or more waveguide couplers configured to couple light from the first input waveguide, the second input waveguide, and the third input waveguide into the output waveguide.

According to certain embodiments, a near-eye display may include a light engine including an array of color pixels, a scanner configured to scan light emitted by the light engine, and display optics configured to direct the light emitted by the light engine and scanned by the scanner to an eye of a user. Each color pixel of the array of color pixels includes a first input waveguide, a second input waveguide, a third input waveguide, and an output waveguide in a waveguide layer; a first light emitter configured to emit light of a first color and optically coupled to the first input waveguide; a second light emitter configured to emit light of a second color and optically coupled to the second input waveguide; a third light emitter configured to emit light of a third color and optically coupled to the third input waveguide; and one or more waveguide couplers configured to couple light from the first input waveguide, the second input waveguide, and the third input waveguide into the output waveguide.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of an optical see-through augmented reality system including a waveguide display.

FIG. 5A illustrates an example of a near-eye display device including a waveguide display.

FIG. 5B illustrates an example of a near-eye display device including a waveguide display according to certain embodiments.

FIG. 6 illustrates an example of an image source assembly in an augmented reality system.

FIG. 7 illustrates an example of a light beam scanning-based near-eye display system according to certain embodiments.

FIG. 8 illustrates an example of a light engine for a light beam scanning-based near-eye display system according to certain embodiments.

FIG. 9 illustrates another example of a light engine for a light beam scanning-based near-eye display system according to certain embodiments.

FIG. 10 illustrates examples of techniques for coupling light from light emitters into waveguides on a photonic integrated circuit (PIC) in a light engine according to certain embodiments.

FIG. 11A illustrates an example of a light engine for a light beam scanning-based near-eye display system according to certain embodiments.

FIG. 11B illustrates another example of a light engine for a light beam scanning-based near-eye display system according to certain embodiments.

FIG. 12 is a simplified block diagram of an electronic system of an example of a near-eye display according to certain embodiments.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to near-eye display. More specifically, and without limitation, techniques disclosed herein relate to light sources for light beam scanning-based near-eye display. Various inventive embodiments are described herein, including devices, systems, methods, structures, materials, processes, and the like.

In near-eye display systems, it is generally desirable that the light source or image source (e.g., a display panel) has a higher resolution, a large color gamut, a large field of view (FOV), a high brightness, and better image quality, in order to improve the immersive experience of using the near-eye display systems. For a battery-powered near-eye display system, it may also be desirable that the system has a higher power efficiency to improve the battery life of the system. In some near-eye display systems, the image sources may be implemented using, for example, a liquid crystal display (LCD), organic light emitting diode (OLED) display, micro-OLED display, inorganic light emitting diode (ILED) display, quantum-dot light emitting diode (QLED) display, micro-light emitting diode (micro-LED) display, active-matrix OLED display (AMOLED), transparent OLED display (TOLED), and the like. These display panels may have limited resolution, brightness, field of view, and power efficiency, and/or may have high costs in order to achieve better resolution, brightness, field of view, and power efficiency.

Light beam scanning-based near-eye display systems may display images to users by, for example, scanning one or more light beams according to a one-dimensional or two-dimensional scanning pattern. The light beams can include laser beams that may have high intensities and high spectral purity. The light beams can be scanned over a large angular range to provide a large field of view. Therefore, light beam scanning-based near-eye display systems may be able to achieve the desired resolution, brightness, field of view, power efficiency, and the like, with a relatively low system complexity and cost. In light beam scanning-based wide FOV near-eye displays, to reduce the required scanning frequency and scanning resolution for achieving the desired frame rate and image resolution, a one-dimensional or two-dimensional array of lasers (or other light emitters) with small pitches (e.g., <=10 μm) may be used to achieve the desired resolution, such as 2 arc-min or better, without using complex optics (e.g., optics for condensing the light beams). However, to achieve the small pitches, red, green, and blue lasers (or other light emitters) may need to be packaged in a confined configuration having a small footprint, which may result in, for example, high electromagnetic interaction (e.g., electromagnetic interference), electrical signal crosstalk, high noise, thermal crosstalk, overheating, intensity and wavelength variations, higher power consumption, and the like. Increasing the spacing between the lasers may reduce or minimize these issues, but may reduce the resolution of the display.

According to certain embodiments disclosed herein, photonic integrated circuit (PIC)-based light engine may be used as a light source in a light beam scanning-based near-eye display for more efficient electrical and thermal management, as well as achieving high resolution, high brightness, high efficiency, and other benefits. In one example, light from each monochromatic (e.g., red, green, or blue) laser or another light emitter may be coupled into an input waveguide in a PIC by, for example, free space coupling with micro-optics, direct edge coupling, grating couplers, or other techniques. The light coupled into the input waveguide may be combined (e.g., through a directional coupler, such as an evanescent waveguide coupler) with light of other two monochromatic colors to generate a light beam of any visible color (which may be referred to herein as a color pixel or simply a pixel) that may be output from a single output waveguide. In this way, an array of N such color pixels may be formed using 3N lasers, and the number of output waveguides at the light emitting end of the light engine can be N (rather than 3N for N sets of R, G, and B sub-pixels). The output waveguides at the light emitting end can be fabricated to have a pitch smaller than about 10 μm to achieve high resolution in two-dimensional light beam scanning-based near-eye display. In some examples, the PIC may include multiple waveguide layers, and the output waveguides for the color pixels may be on two or more waveguide layers to form a two-dimensional array of color pixels that emits a two-dimensional array of color light beams. In some examples, multiple PICs may be stacked (e.g., bonded) together to form a light engine that includes a two-dimensional array of color pixels configured to emit a two-dimensional array of light beams.

In addition, in some examples, a small fraction (e.g., about 1%) of the light from a light emitter and coupled into an input waveguide may be coupled out of the input waveguide and directed to a photodetector (e.g., a photodiode) to monitor the intensity of the light coupled into each input waveguide, such that light intensity variations across the array of output waveguides (e.g., due to manufacturing variation of the lasers, junction temperature variation across the lasers, variation in the light coupling efficiency, etc.) may be corrected by, for example, adjusting the driving signals for driving the lasers, to achieve the desired color and brightness at each color pixel. In this way, an array of color pixels having a small pitch and a high brightness uniformity may be formed for use in laser beam scanning to achieve a high resolution and high brightness uniformity in a near-eye display. In some examples, the light engine may also include one or more waveguides coupled to one or more light emitters for emitting light (e.g., infrared light) for eye or face tracking, and one or more waveguides coupled to one or more photosensors (e.g., image sensors) for receiving light reflected by the user's eye or face to determine the gazing direction of the user's eye.

The light engine described herein may be used in conjunction with various technologies, such as an artificial reality system. An artificial reality system, such as a head-mounted display (HMD) or heads-up display (HUD) system, generally includes a display configured to present artificial images that depict objects in a virtual environment. The display may present virtual objects or combine images of real objects with virtual objects, as in virtual reality (VR), augmented reality (AR), or mixed reality (MR) applications. For example, in an AR system, a user may view both displayed images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through). In some AR systems, the artificial images may be presented to users using an LED-based display subsystem.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

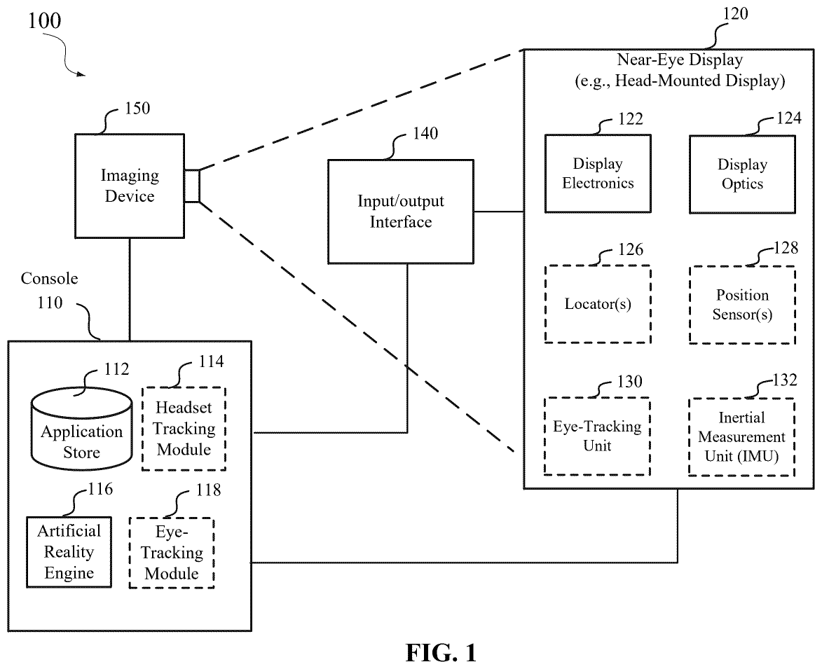

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

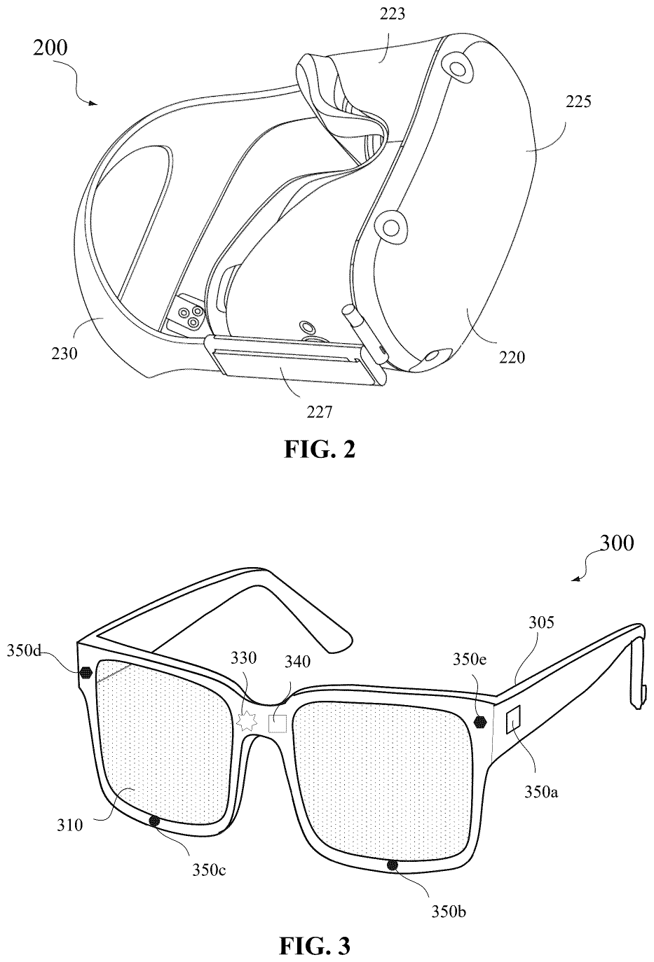

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be an LED, a corner cube reflector, a reflective marker, a type of light source that contrasts with an environment in which near-eye display 120 operates, or any combination thereof. In embodiments where locators 126 are active components (e.g., LEDs or other types of light emitting devices).

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120.

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future location of near-eye display 120. Headset tracking module 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. Artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking module 118 to determine the eye's orientation more accurately.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. Camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

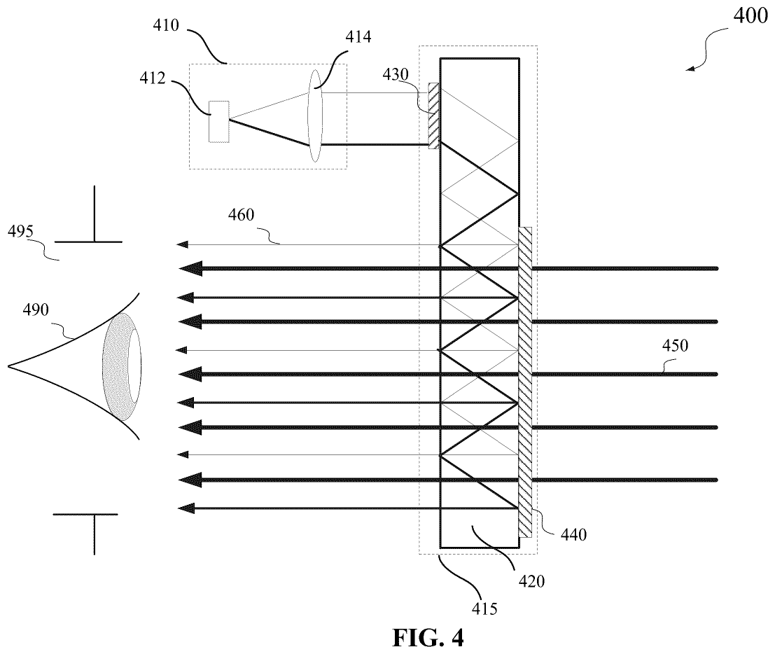

FIG. 4 illustrates an example of an optical see-through augmented reality system 400 including a waveguide display according to certain embodiments. Augmented reality system 400 may include a projector 410 and a combiner 415. Projector 410 may include a light source or image source 412 and projector optics 414. In some embodiments, light source or image source 412 may include one or more micro-LED devices described above. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, an LED, and/or a micro-LED described above. In some embodiments, image source 412 may include a plurality of light sources (e.g., an array of micro-LEDs described above), each emitting a monochromatic image light corresponding to a primary color (e.g., red, green, or blue). In some embodiments, image source 412 may include three two-dimensional arrays of micro-LEDs, where each two-dimensional array of micro-LEDs may include micro-LEDs configured to emit light of a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. For example, in some embodiments, image source 412 may include one or more one-dimensional arrays or elongated two-dimensional arrays of micro-LEDs, and projector optics 414 may include one or more one-dimensional scanners (e.g., micro-mirrors or prisms) configured to scan the one-dimensional arrays or elongated two-dimensional arrays of micro-LEDs to generate image frames. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Input coupler 430 may include a volume holographic grating, a diffractive optical element (DOE) (e.g., a surface-relief grating), a slanted surface of substrate 420, or a refractive coupler (e.g., a wedge or a prism). For example, input coupler 430 may include a reflective volume Bragg grating or a transmissive volume Bragg grating. Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 10 mm or more. Substrate 420 may be transparent to visible light.

Substrate 420 may include or may be coupled to a plurality of output couplers 440, each configured to extract at least a portion of the light guided by and propagating within substrate 420 from substrate 420, and direct extracted light 460 to an eyebox 495 where an eye 490 of the user of augmented reality system 400 may be located when augmented reality system 400 is in use. The plurality of output couplers 440 may replicate the exit pupil to increase the size of eyebox 495 such that the displayed image is visible in a larger area. As input coupler 430, output couplers 440 may include grating couplers (e.g., volume holographic gratings or surface-relief gratings), other diffraction optical elements (DOEs), prisms, etc. For example, output couplers 440 may include reflective volume Bragg gratings or transmissive volume Bragg gratings. Output couplers 440 may have different coupling (e.g., diffraction) efficiencies at different locations. Substrate 420 may also allow light 450 from the environment in front of combiner 415 to pass through with little or no loss. Output couplers 440 may also allow light 450 to pass through with little loss. For example, in some implementations, output couplers 440 may have a very low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 in certain desired directions (i.e., diffraction angles) with little loss. As a result, the user may be able to view combined images of the environment in front of combiner 415 and images of virtual objects projected by projector 410.

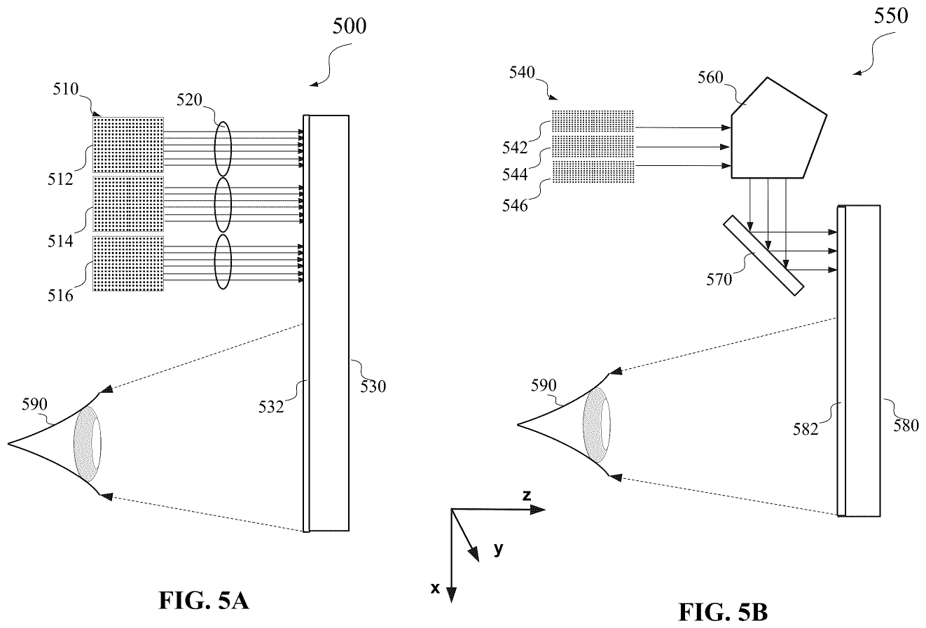

FIG. 5A illustrates an example of a near-eye display (NED) device 500 including a waveguide display 530 according to certain embodiments. NED device 500 may be an example of near-eye display 120, augmented reality system 400, or another type of display device. NED device 500 may include a light source 510, projection optics 520, and waveguide display 530. Light source 510 may include multiple panels of light emitters for different colors, such as a panel of red light emitters 512, a panel of green light emitters 514, and a panel of blue light emitters 516. The red light emitters 512 are organized into an array; the green light emitters 514 are organized into an array; and the blue light emitters 516 are organized into an array. The dimensions and pitches of light emitters in light source 510 may be small. For example, each light emitter may have a diameter less than 2 μm (e.g., about 1.2 μm) and the pitch may be less than 2 μm (e.g., about 1.5 μm). As such, the number of light emitters in each red light emitters 512, green light emitters 514, and blue light emitters 516 can be equal to or greater than the number of pixels in a display image, such as 960×720, 1280×720, 1440×1080, 1920×1080, 2160×1080, 2560×1080, or more pixels. Thus, a display image may be generated simultaneously by light source 510. A scanning element may not be used in NED device 500.

Before reaching waveguide display 530, the light emitted by light source 510 may be conditioned by projection optics 520, which may include a lens array. Projection optics 520 may collimate or focus the light emitted by light source 510 to waveguide display 530, which may include a coupler 532 for coupling the light emitted by light source 510 into waveguide display 530. The light coupled into waveguide display 530 may propagate within waveguide display 530 through, for example, total internal reflection as described above with respect to FIG. 4. Coupler 532 may also couple portions of the light propagating within waveguide display 530 out of waveguide display 530 and towards user's eye 590.

FIG. 5B illustrates an example of a near-eye display (NED) device 550 including a waveguide display 580 according to certain embodiments. In some embodiments, NED device 550 may use a scanning mirror 570 to project light from a light source 540 to an image field where a user's eye 590 may be located. NED device 550 may be an example of near-eye display 120, augmented reality system 400, or another type of display device. Light source 540 may include one or more rows or one or more columns of light emitters of different colors, such as multiple rows of red light emitters 542, multiple rows of green light emitters 544, and multiple rows of blue light emitters 546. For example, red light emitters 542, green light emitters 544, and blue light emitters 546 may each include N rows, each row including, for example, 2560 light emitters (pixels). The red light emitters 542 are organized into an array; the green light emitters 544 are organized into an array; and the blue light emitters 546 are organized into an array. In some embodiments, light source 540 may include a single line of light emitters for each color. In some embodiments, light source 540 may include multiple columns of light emitters for each of red, green, and blue colors, where each column may include, for example, 1080 light emitters. In some embodiments, the dimensions and/or pitches of the light emitters in light source 540 may be relatively large (e.g., about 3-5 μm) and thus light source 540 may not include sufficient light emitters for simultaneously generating a full display image. For example, the number of light emitters for a single color may be fewer than the number of pixels (e.g., 2560×1080 pixels) in a display image. The light emitted by light source 540 may be a set of collimated or diverging beams of light.

Before reaching scanning mirror 570, the light emitted by light source 540 may be conditioned by various optical devices, such as collimating lenses or a freeform optical element 560. Freeform optical element 560 may include, for example, a multi-facet prism or another light folding element that may direct the light emitted by light source 540 towards scanning mirror 570, such as changing the propagation direction of the light emitted by light source 540 by, for example, about 90° or larger. In some embodiments, freeform optical element 560 may be rotatable to scan the light. Scanning mirror 570 and/or freeform optical element 560 may reflect and project the light emitted by light source 540 to waveguide display 580, which may include a coupler 582 for coupling the light emitted by light source 540 into waveguide display 580. The light coupled into waveguide display 580 may propagate within waveguide display 580 through, for example, total internal reflection as described above with respect to FIG. 4. Coupler 582 may also couple portions of the light propagating within waveguide display 580 out of waveguide display 580 and towards user's eye 590.

Scanning mirror 570 may include a microelectromechanical system (MEMS) mirror or any other suitable mirrors. Scanning mirror 570 may rotate to scan in one or two dimensions. As scanning mirror 570 rotates, the light emitted by light source 540 may be directed to a different area of waveguide display 580 such that a full display image may be projected onto waveguide display 580 and directed to user's eye 590 by waveguide display 580 in each scanning cycle. For example, in embodiments where light source 540 includes light emitters for all pixels in one or more rows or columns, scanning mirror 570 may be rotated in the column or row direction (e.g., x or y direction) to scan an image. In embodiments where light source 540 includes light emitters for some but not all pixels in one or more rows or columns, scanning mirror 570 may be rotated in both the row and column directions (e.g., both x and y directions) to project a display image (e.g., using a raster-type scanning pattern).

NED device 550 may operate in predefined display periods. A display period (e.g., display cycle) may refer to a duration of time in which a full image is scanned or projected. For example, a display period may be a reciprocal of the desired frame rate. In NED device 550 that includes scanning mirror 570, the display period may also be referred to as a scanning period or scanning cycle. The light generation by light source 540 may be synchronized with the rotation of scanning mirror 570. For example, each scanning cycle may include multiple scanning steps, where light source 540 may generate a different light pattern in each respective scanning step.

In each scanning cycle, as scanning mirror 570 rotates, a display image may be projected onto waveguide display 580 and user's eye 590. The actual color value and light intensity (e.g., brightness) of a given pixel location of the display image may be an average of the light beams of the three colors (e.g., red, green, and blue) illuminating the pixel location during the scanning period. After completing a scanning period, scanning mirror 570 may revert back to the initial position to project light for the first few rows of the next display image or may rotate in a reverse direction or scan pattern to project light for the next display image, where a new set of driving signals may be fed to light source 540. The same process may be repeated as scanning mirror 570 rotates in each scanning cycle. As such, different images may be projected to user's eye 590 in different scanning cycles.

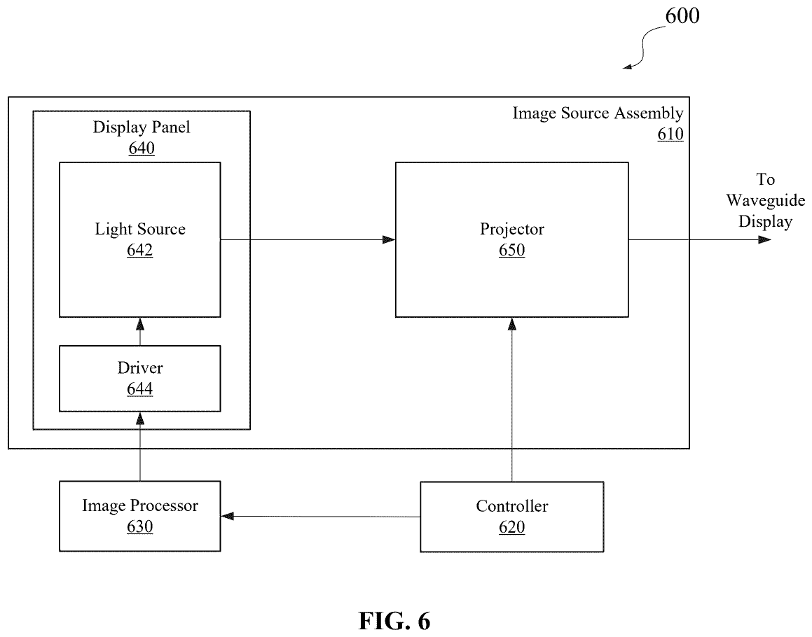

FIG. 6 illustrates an example of an image source assembly 610 in a near-eye display system 600 according to certain embodiments. Image source assembly 610 may include, for example, a display panel 640 that may generate display images to be projected to the user's eyes, and a projector 650 that may project the display images generated by display panel 640 to a waveguide display as described above with respect to FIGS. 4-5B. Display panel 640 may include a light source 642 and a drive circuit 644 for light source 642. Light source 642 may include, for example, light source 510 or 540. Projector 650 may include, for example, freeform optical element 560, scanning mirror 570, and/or projection optics 520 described above. Near-eye display system 600 may also include a controller 620 that synchronously controls light source 642 and projector 650 (e.g., scanning mirror 570). Image source assembly 610 may generate and output an image light to a waveguide display (not shown in FIG. 6), such as waveguide display 530 or 580. As described above, the waveguide display may receive the image light at one or more input-coupling elements, and guide the received image light to one or more output-coupling elements. The input and output coupling elements may include, for example, a diffraction grating, a holographic grating, a prism, or any combination thereof. The input-coupling element may be chosen such that total internal reflection occurs with the waveguide display. The output-coupling element may couple portions of the total internally reflected image light out of the waveguide display.

As described above, light source 642 may include a plurality of light emitters arranged in an array or a matrix. Each light emitter may emit monochromatic light, such as red light, blue light, green light, infra-red light, and the like. While RGB colors are often discussed in this disclosure, embodiments described herein are not limited to using red, green, and blue as primary colors. Other colors can also be used as the primary colors of near-eye display system 600. In some embodiments, a display panel in accordance with an embodiment may use more than three primary colors. Each pixel in light source 642 may include three subpixels that include a red micro-LED, a green micro-LED, and a blue micro-LED. A semiconductor LED generally includes an active light emitting layer within multiple layers of semiconductor materials. The multiple layers of semiconductor materials may include different compound materials or a same base material with different dopants and/or different doping densities. For example, the multiple layers of semiconductor materials may include an n-type material layer, an active region that may include hetero-structures (e.g., one or more quantum wells), and a p-type material layer. The multiple layers of semiconductor materials may be grown on a surface of a substrate having a certain orientation.

Controller 620 may control the image rendering operations of image source assembly 610, such as the operations of light source 642 and/or projector 650. For example, controller 620 may determine instructions for image source assembly 610 to render one or more display images. The instructions may include display instructions and scanning instructions. In some embodiments, the display instructions may include an image file (e.g., a bitmap file). The display instructions may be received from, for example, a console, such as console 110 described above with respect to FIG. 1. The scanning instructions may be used by image source assembly 610 to generate image light. The scanning instructions may specify, for example, a type of a source of image light (e.g., monochromatic or polychromatic), a scanning rate, an orientation of a scanning apparatus, one or more illumination parameters, or any combination thereof. Controller 620 may include a combination of hardware, software, and/or firmware not shown here so as not to obscure other aspects of the present disclosure.

In some embodiments, controller 620 may be a graphics processing unit (GPU) of a display device. In other embodiments, controller 620 may be other kinds of processors. The operations performed by controller 620 may include taking content for display and dividing the content into discrete sections. Controller 620 may provide to light source 642 scanning instructions that include an address corresponding to an individual source element of light source 642 and/or an electrical bias applied to the individual source element. Controller 620 may instruct light source 642 to sequentially present the discrete sections using light emitters corresponding to one or more rows of pixels in an image ultimately displayed to the user. Controller 620 may also instruct projector 650 to perform different adjustments of the light. For example, controller 620 may control projector 650 to scan the discrete sections to different areas of a coupling element of the waveguide display (e.g., waveguide display 580) as described above with respect to FIG. 5B. As such, at the exit pupil of the waveguide display, each discrete portion is presented in a different respective location. While each discrete section is presented at a different respective time, the presentation and scanning of the discrete sections occur fast enough such that a user's eye may integrate the different sections into a single image or series of images.

Image processor 630 may be a general-purpose processor and/or one or more application-specific circuits that are dedicated to performing the features described herein. In one embodiment, a general-purpose processor may be coupled to a memory to execute software instructions that cause the processor to perform certain processes described herein. In another embodiment, image processor 630 may be one or more circuits that are dedicated to performing certain features. While image processor 630 in FIG. 6 is shown as a stand-alone unit that is separate from controller 620 and drive circuit 644, image processor 630 may be a sub-unit of controller 620 or drive circuit 644 in other embodiments. In other words, in those embodiments, controller 620 or drive circuit 644 may perform various image processing functions of image processor 630. Image processor 630 may also be referred to as an image processing circuit.

In the example shown in FIG. 6, light source 642 may be driven by drive circuit 644, based on data or instructions (e.g., display and scanning instructions) sent from controller 620 or image processor 630. In one embodiment, drive circuit 644 may include a circuit panel that connects to and mechanically holds various light emitters of light source 642. Light source 642 may emit light in accordance with one or more illumination parameters that are set by the controller 620 and potentially adjusted by image processor 630 and drive circuit 644. An illumination parameter may be used by light source 642 to generate light. An illumination parameter may include, for example, source wavelength, pulse rate, pulse amplitude, beam type (continuous or pulsed), other parameter(s) that may affect the emitted light, or any combination thereof. In some embodiments, the source light generated by light source 642 may include multiple beams of red light, green light, and blue light, or any combination thereof.

Projector 650 may perform a set of optical functions, such as focusing, combining, conditioning, or scanning the image light generated by light source 642. In some embodiments, projector 650 may include a combining assembly, a light conditioning assembly, or a scanning mirror assembly. Projector 650 may include one or more optical components that optically adjust and potentially re-direct the light from light source 642. One example of the adjustment of light may include conditioning the light, such as expanding, collimating, correcting for one or more optical errors (e.g., field curvature, chromatic aberration, etc.), some other adjustments of the light, or any combination thereof. The optical components of projector 650 may include, for example, lenses, mirrors, apertures, gratings, or any combination thereof.

Projector 650 may redirect image light via its one or more reflective and/or refractive portions so that the image light is projected at certain orientations toward the waveguide display. The location where the image light is redirected toward the waveguide display may depend on specific orientations of the one or more reflective and/or refractive portions. In some embodiments, projector 650 includes a single scanning mirror that scans in at least two dimensions. In other embodiments, projector 650 may include a plurality of scanning mirrors that each scan in directions orthogonal to each other. Projector 650 may perform a raster scan (horizontally or vertically), a bi-resonant scan, or any combination thereof. In some embodiments, projector 650 may perform a controlled vibration along the horizontal and/or vertical directions with a specific frequency of oscillation to scan along two dimensions and generate a two-dimensional projected image of the media presented to user's eyes. In other embodiments, projector 650 may include a lens or prism that may serve similar or the same function as one or more scanning mirrors. In some embodiments, image source assembly 610 may not include a projector, where the light emitted by light source 642 may be directly incident on the waveguide display.

As described above, light beam scanning-based near-eye display systems may display images to users by, for example, scanning one or more light beams according to a one-dimensional or two-dimensional scanning pattern. The light beams can include laser beams that may have high intensities and high spectral purity. The light beams can be scanned over a large angular range to provide a large field of view. Therefore, light beam scanning-based near-eye display systems may be able to achieve the desired resolution, brightness, field of view, power efficiency, and the like, with a relatively low system complexity and cost. In light beam scanning-based wide FOV near-eye displays, to reduce the required scanning frequency and scanning resolution for achieving the desired frame rate and image resolution, a one-dimensional or two-dimensional array of lasers (or other light emitters) with small pitches (e.g., <=10 μm) may be used to achieve the desired resolution, such as 2 arc-min or better, without using complex optics (e.g., optics for condensing the light beams). However, to achieve the small pitches, red, green, and blue lasers (or other light emitters) may need to be packaged in a confined configuration having a small footprint, which may result in, for example, high electromagnetic interaction (e.g., electromagnetic interference), electrical signal crosstalk, high noise, thermal crosstalk, overheating, intensity and wavelength variations, higher power consumption, and the like. Increasing the spacing between the lasers may reduce or minimize these issues, but may reduce the resolution of the display.

According to certain embodiments disclosed herein, photonic integrated circuit (PIC)-based light engine may be used as a light source in a light beam scanning-based near-eye display for more efficient electrical and thermal management, as well as achieving high resolution, high brightness, high efficiency, and other benefits. In one example, light from each monochromatic (e.g., red, green, or blue) laser or another light emitter may be coupled into an input waveguide in a PIC by, for example, free space coupling with micro-optics, direct edge coupling, grating couplers, or other techniques. The light coupled into the input waveguide may be combined (e.g., through a directional coupler, such as an evanescent waveguide coupler) with light of other two monochromatic colors coupled into two other input waveguides to generate a light beam of any visible color (which may be referred to herein as a color pixel or simply a pixel) that may be output from a single output waveguide. In this way, an array of N such color pixels may be formed using 3N lasers, and the number of output waveguides at the light emitting end of the light engine can be N (rather than 3N for N sets of R, G, and B sub-pixels). The output waveguides at the light emitting end can be fabricated to have a pitch smaller than about 10 μm to achieve high resolution in two-dimensional light beam scanning-based near-eye display. In some examples, the PIC may include multiple waveguide layers, and the output waveguides for the color pixels may be on two or more waveguide layers to form a two-dimensional array of color pixels that emits a two-dimensional array of color light beams. In some examples, multiple PICs may be stacked (e.g., bonded) together to form a light engine that includes a two-dimensional array of color pixels configured to emit a two-dimensional array of light beams.

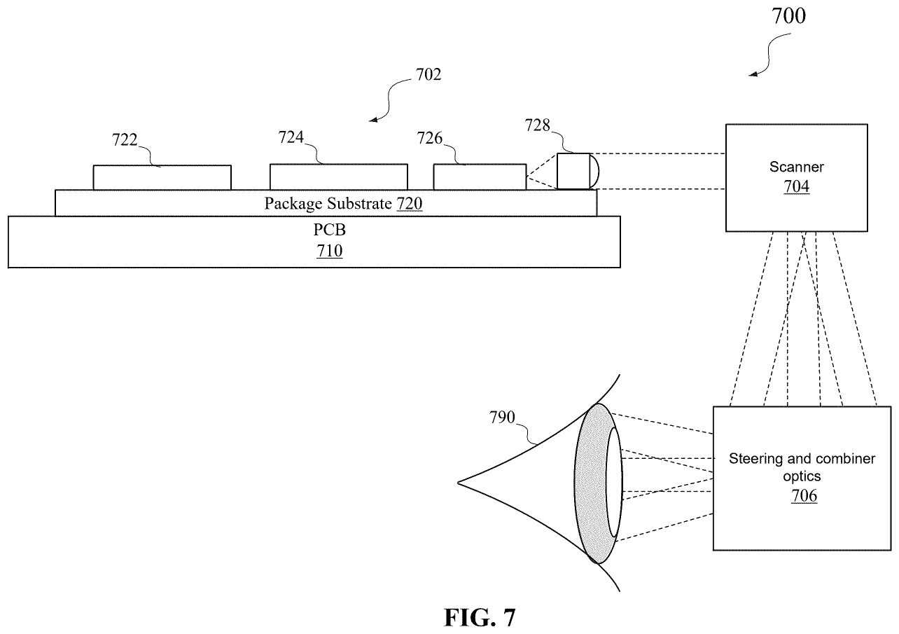

FIG. 7 illustrates an example of a light beam scanning-based near-eye display system 700 according to certain embodiments. In the illustrated example, near-eye display system 700 may include a display engine 702, a scanner 704, and steering and combiner optics 706. Display engine 702 may emit an array of color light beams, which may be scanned by scanner 704 according to a one-dimensional or two-dimensional scan pattern to generate two-dimensional images. Display engine 702 and scanner 704 may be controlled by a controller (e.g., controller 620), such that the colors and intensities of the color light beams may vary as scanner 704 scans at different directions, thereby generating two-dimensional color images with the desired content. The two-dimensional color images may be presented to user's eyes by steering and combiner optics 706, such as a waveguide, a prism, a partial reflective mirror, a birdbath combiner, or a combination thereof. Steering and combiner optics 706 may project the two-dimensional color images to a user's eye 790. In some examples, steering and combiner optics 706 may replicate the pupils as described above.

In the example shown in FIG. 7, display engine 702 may include a printed circuit board (PCB) 710, an optional package substrate 720, and electrical and photonic integrated circuits bonded to PCB 710 or package substrate 720. The electrical and photonic integrated circuits may include, for example, digital circuits 722, analog circuits 724, a light engine 726, and the like. Digital circuits 722 may include, for example, a graphic engine (e.g., a graphic processing unit or another image processor), digital driving circuits, eye-tracking data processing circuits, and the like, as described above with respect to, for example, FIGS. 1 and 6. Analog circuits 724 may include, for example, analog driver circuits for driving the light emitters (e.g., semiconductor layers such as edge-emitting semiconductor layers) and the eye-tracking light source. For example, analog circuits 724 may generate driving currents having the desired intensities for driving the light emitters to emit light beams with the desired light intensities.

Light engine 726 may include an array of color pixels configured to emit an array of color light beams, which may be collimated by collimation optics 728 and scanned by scanner 704 as described above. Light engine 726 may include a plurality of monochromatic light emitters, such as edge-emitting lasers that emit red, green, and blue light. Light engine 726 may also include a photonic integrated circuit (PIC) formed on a substrate (e.g., a silicon substrate, glass substrate, or another semiconductor or dielectric substrate). The photonic integrated circuit may include one or more waveguide layers and one or more cladding layers. Waveguides and other passive integrated photonic elements, such as beam splitters, directional couplers, layer-to-layer couplers, mode-matching input/output couplers, and the like.

The monochromatic light beams emitted by each monochromatic (e.g., red, green, or blue) laser may be coupled into an input waveguide in the PIC by, for example, free space coupling with micro-optics, direct edge coupling, a grating coupler, or other techniques. The light coupled into the input waveguide may be combined (e.g., through a directional coupler, such as an evanescent waveguide coupler) with light of other two monochromatic colors coupled into two other input waveguides to generate a light beam of visible light of any color that may be output from a single output waveguide. In this way, an array of N such color pixels may be formed using 3N lasers, and the number of output waveguides at the light emitting end of light engine 726 can be N (rather than 3N for N sets of R, G, and B sub-pixels). The output waveguides at the light emitting end can be fabricated to have a pitch smaller than about 10 μm to achieve high resolution in two-dimensional light beam scanning-based near-eye display.

In addition, in some examples, a small fraction (e.g., about 1%) of the light from a light emitter and coupled into an input waveguide may be coupled out of the input waveguide and directed to a photodetector (e.g., a photodiode) to monitor the intensity of the light coupled into each input waveguide. The measured light intensity may be processed by digital circuits 722 and/or analog circuits 724 to adjust the driving currents for the light emitters. In this way, light intensity variations across the array of output waveguides (e.g., due to manufacturing variation of the lasers, junction temperature variation across the lasers, variation in the light coupling efficiency, etc.) may be corrected by, for example, adjusting the driving signals for driving the lasers, to achieve the desired color and brightness at each color pixel.

In some examples, light engine 726 may also include one or more light emitters for emitting light for eye or face tracking (e.g., infrared light), one or more waveguides coupled to the one or more light emitters to transmit the light for eye or face tracking, one or more waveguides coupled to one or more photosensors (e.g., image sensors) for receiving light reflected by the user's eye or face. The one or more light emitters for emitting light for eye or face tracking may be controlled by digital circuits 722 and/or analog circuits 724. Signals measured by the one or more photosensors may be processed by digital circuits 722 to determine, for example, the gazing direction of the user's eye, the image to display to the user, the intensities and/or resolutions of the pixels at different regions of the image, and the like. Digital circuits 722 may then control analog circuits 724 to drive the monochromatic light emitters accordingly as described above.

Collimation optics 728 may include one or more lenses that are positioned with respect to the light-emitting edges of light engine 726 such that light beam from each color pixel (e.g., at an end of each output waveguide in the PIC of light engine 726) may be collimated. The collimated beam may be directed towards scanner 704 and may be deflected by scanner 704 towards desired directions. In some examples, collimation optics 728 may include one lens. In some examples, collimation optics 728 may include an array of micro-lenses. In some examples, one color pixel may have a respective corresponding micro-lens in collimation optics 728.

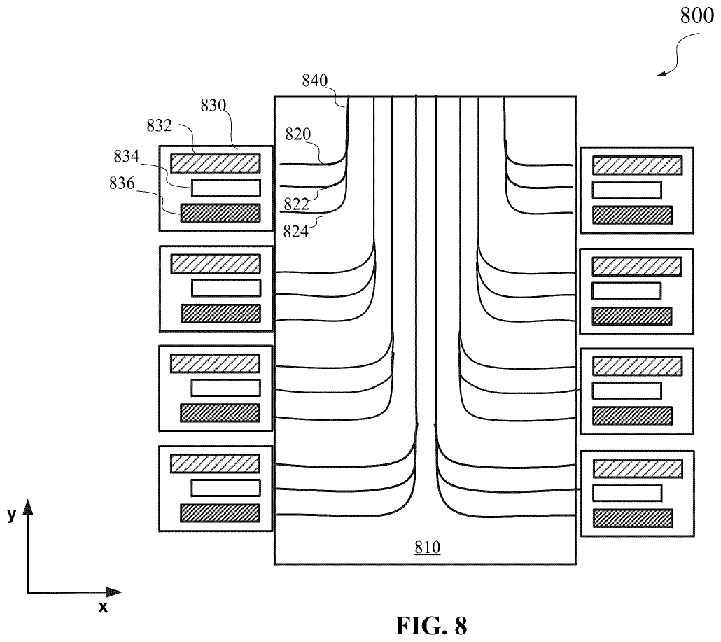

FIG. 8 illustrates an example of a light engine 800 for a light beam scanning-based near-eye display system according to certain embodiments. Light engine 800 may be an example of light engine 726 described above. In the illustrated example, light engine 800 includes a photonic integrated circuit 810 and a plurality of monochromatic light emitters (e.g., edge-emitting semiconductor layers). PIC 810 may include optical waveguides formed on a substrate. The waveguides may include waveguide cores formed by materials that are transparent to visible light and have higher refractive indices, such as silicon nitride (e.g., Si₃O₄), aluminum oxide (e.g., Al₂O₃), or other oxides or nitrides. The waveguides may also include waveguide cladding layers that include materials with refractive indices lower than the refractive indices of the corresponding waveguide cores, such as silicon dioxide (SiO₂) or other dielectric materials. The waveguides may have low losses for visible light, and may form various passive optical components, such as waveguide beam splitters, waveguide beam combiners, directional couplers, layer-to-layer couplers, mode-matching input/output couplers, and the like. The waveguide cores can be fabricated to have a width about a few microns or less than a micron in a cross-section of a waveguide core. The separation between the waveguide cores can be about a few microns, such as less than about 10 microns.

The monochromatic light emitters may include light emitters that may emit red, green, and blue light. The light emitters may include discrete light emitters on individual semiconductor dies, or may include arrays of light emitters, such as multi-ridge waveguide lasers, where each array of light emitters may be on a same semiconductor die. In the illustrated example, the light emitters may be grouped, where each group 830 may include a red light emitter 832, a green light emitter 834, and a blue light emitter 836 mounted on a substrate. in some examples, the substrate for each group 830 of light emitters may be mounted on the substrate of PIC 810. In some examples, the substrate for each group 830 of light emitters and the substrate of PIC 810 may be mounted on a same support structure, such as another substrate, a package substrate (e.g., package substrate 720), or a PCB (e.g., PCB 710). Light emitted by red light emitter 832, green light emitter 834, and blue light emitter 836 in each group 830 may be coupled into an input waveguide 820, an input waveguide 822, and an input waveguide 824, respectively, and may be coupled into a single output waveguide 840 by, for example, one or more directional couplers, such as one or more evanescent waveguide couplers. The light combined in output waveguide 840 may have a certain visible color, depending on the relative intensities of the red light, green light, and blue light that are combined. Therefore, the light emitted at the end of each output waveguide 840 may have a desired color and intensity (or brightness) that are determined by the intensities of the red light, green light, and blue light that are coupled into the output waveguide 840. In this way, light emitted by the light emitters in each group 830 may be coupled into three input waveguides in PIC 810 and then coupled into a respective output waveguide 840 to combine into a color image pixel having a certain color and a certain intensity (or brightness).

In some examples, light coupled into input waveguides 820, 822, and 824 may be split by waveguide beam splitters (not shown in FIG. 8), where a small fraction (e.g., about 1%) of the light coupled into each input waveguide 820, 822, or 824 may be coupled into another waveguide and be guided towards a photodetector (not shown in FIG. 8) that may measure the power or intensity of the light. The measured power of the light may be used to estimate the total power of the light coupled into each input waveguide 820, 822, or 824. For example, as described above with respect to FIG. 7, the measured light power may be processed by digital circuits 722 and used for controlling analog circuits 724 to adjust the driving currents for the light emitters, so that the light in each input waveguide 820, 822, or 824 may have a desired intensity to form a color pixel with a desired color and brightness.

Light engine 800 may have a width about a few millimeters or tens of millimeters, and a length about a few millimeters or tens of millimeters, such that it may be suitable for use in a head-mounted device. The number of color pixels of light engine 800 may depend on the dimension of light engine 800 and the dimensions of the monochromatic light emitters. In some examples, light engine 800 may include tens of groups of light emitters and tens of output waveguides to form tens of color pixels. In other examples, light engine 800 may include more or fewer color pixels. Because of the small sizes of output waveguides 840 and the small distance (e.g., no more than 10 μm) between adjacent output waveguides 840, the array of color pixels formed by the array of output waveguides 840 can have a small pitch and thus a high resolution.

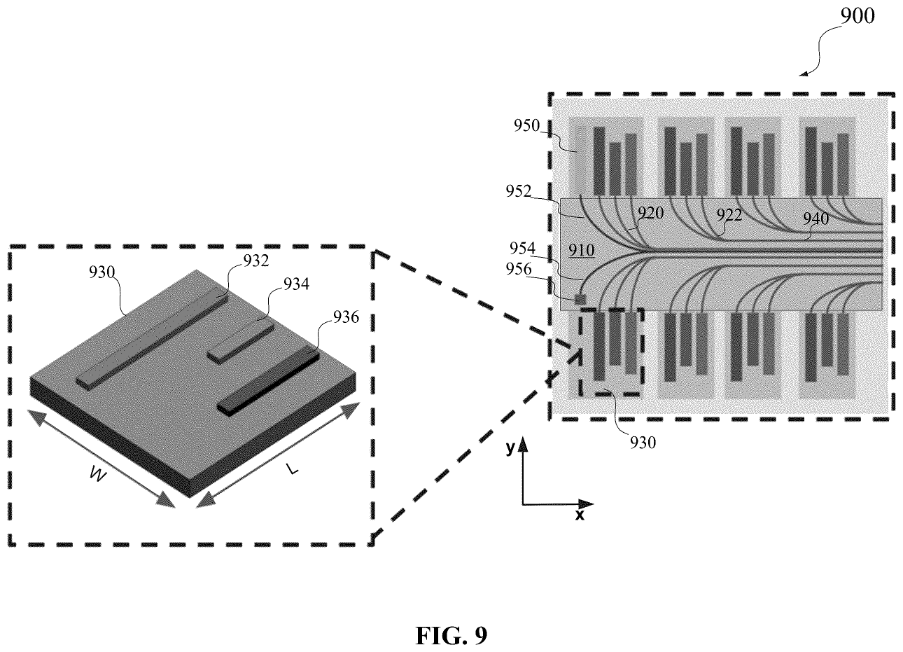

FIG. 9 illustrates another example of a light engine 900 for a light beam scanning-based near-eye display system according to certain embodiments. Light engine 900 may be similar to light engine 800 and may be another example of light engine 726 described above. In the illustrated example, light engine 900 includes a photonic integrated circuit 910 and a plurality of monochromatic light emitters (e.g., edge-emitting semiconductor layers). PIC 910 may include input waveguides 920, output waveguides 940, and other passive optical components (e.g., waveguide beam splitters, waveguide beam combiners, and directional couplers) formed by waveguides in one or more waveguide layers on a substrate. The waveguides may include waveguide cores formed by materials that are transparent to visible light and have higher refractive indices, such as silicon nitride (e.g., Si₃O₄), aluminum oxide (e.g., Al₂O₃), or other oxides or nitrides. The waveguides may also include waveguide cladding layers that include materials with refractive indices lower than the refractive indices of the corresponding waveguide cores, such as silicon dioxide (SiO₂) or other dielectric materials. The waveguides may have low losses for visible light. The waveguide cores of the waveguides in PIC 910 can be fabricated to have a width about a few microns or less than a micron in a cross-section of a waveguide core. The separation between the waveguide cores can be about a few microns, such as less than about 10 microns.

The monochromatic light emitters may include light emitters that may emit red, green, and blue light. The light emitters may include discrete light emitters on individual semiconductor dies, or may include arrays of light emitters, such as multi-ridge waveguide lasers, where each array of light emitters may be on a same semiconductor die. In the illustrated example, the light emitters may be grouped, where each group 930 may include a red light emitter 932, a green light emitter 934, and a blue light emitter 936 bonded on a substrate. Each group 930 may have a width about a few millimeters (e.g., 1-2 mm) or smaller and a length about a few millimeters (e.g., 1-2 mm) or smaller. In some examples, the substrate for each group 930 of light emitters may be mounted on the substrate of PIC 910. In some examples, the substrate for each group 930 of light emitters and the substrate of PIC 910 may be mounted on a same support structure, such as another substrate, a package substrate (e.g., package substrate 720), or a PCB (e.g., PCB 710). Light emitted by red light emitter 932, green light emitter 934, and blue light emitter 936 in each group 930 may be coupled into input waveguides 920 by, for example, free space coupling with micro-optics, direct edge coupling, a grating couplers, or other techniques. The light of different colors coupled into input waveguides 920 may be coupled into a single output waveguide 940 using directional couplers 922, such as evanescent waveguide couplers. The light combined in output waveguide 940 may have a certain visible color, depending on the relative intensities of the red light, green light, and blue light that are combined. Therefore, the light emitted at the end of each output waveguide 940 may have a desired color and intensity (or brightness) that are determined by the intensities of the red light, green light, and blue light that are coupled into the output waveguide 940. In this way, light emitted by the light emitters in each group 930 may be coupled into three input waveguides in PIC 910 and then coupled into a respective output waveguide 940 to combine into a color image pixel having a certain color and a certain intensity (or brightness).

In some examples, light coupled into input waveguides 920 may be split by waveguide beam splitters (not shown in FIG. 9), where a small fraction (e.g., about 1%) of the light coupled into each input waveguide 920 may be coupled into another waveguide and be guided towards a photodetector (not shown in FIG. 9) that may measure the power of the light. The measured power of the light may be used to estimate the total power of the light coupled into each input waveguide 920. For example, as described above with respect to FIG. 7, the measured light power may be processed by digital circuits 722 and used for controlling analog circuits 724 to adjust the driving currents for the light emitters, so that the light in each input waveguide 920 may have a desired intensity to form a color pixel with a desired color and brightness.

In addition, light engine 900 may include a light emitter 950 configured to emit eye-tracking light that is invisible to human eyes, such as infrared light. The eye-tracking light emitted by light emitter 950 may be coupled into a waveguide 952 and guided by waveguide 952 towards the light emitting end of PIC 910. The eye-tracking light emitted at the light emitting end of PIC 910 may be directed together with light of the color pixels towards the user's eye, for example, by scanner 704 and steering and combiner optics 706. A fraction of the eye-tracking light reflected by the user's eye may be coupled into another waveguide 954 that may guide the eye-tracking light to a photosensor 956 (e.g., an image sensor), or may be coupled into waveguide 952 and directed towards photosensor 956 by a directional coupler. Photosensor 956 may generate signals indicating the gazing direction of the user's eye. Based on the gazing direction of the user's eye estimated using the signals generated by photosensor 956, the display engine (e.g., display engine 702) and/or image processor may render appropriated images, where the contents, the resolutions at different regions, and the brightness at different regions of the images may be determined based on the estimated gazing direction. For example, the resolution and/or brightness of the region of an image in the gazing direction may be higher, while the resolution and/or brightness of the regions of the image away from the gazing direction may be lower.

Light engine 900 may have a width about a few millimeters or tens of millimeters, and a length about a few millimeters or tens of millimeters, such that it may be suitable for use in a head-mounted device. The number of color pixels of light engine 900 may depend on the dimension of light engine 900 and the dimensions of the monochromatic light emitters. In some examples, light engine 900 may include tens of groups of light emitters and tens of output waveguides to form tens of color pixels. In other examples, light engine 900 may include more or fewer color pixels. Because of the small sizes of output waveguides 940 and the small distance between adjacent output waveguides 940, the array of color pixels formed by the array of output waveguides 940 can have a small pitch and thus a high resolution.

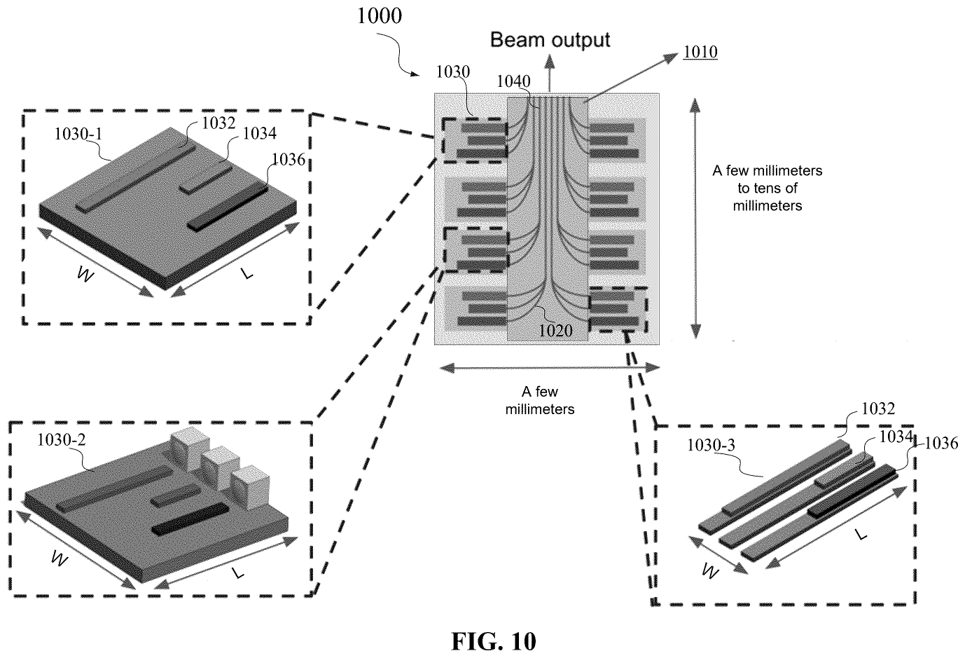

FIG. 10 illustrates examples of techniques for coupling light from light emitters (e.g., lasers) into waveguides on a photonic integrated circuit (PIC) in a light engine 1000 according to certain embodiments. As light engines 800 and 900, light engine 1000 may include a photonic integrated circuit 1010 and a plurality of monochromatic light emitters (e.g., edge-emitting semiconductor layers). PIC 1010 may be similar to PIC 810 or 910, and may include input waveguides 1020 formed on a substrate. Input waveguides 1020 may be similar to input waveguides 820, 822, 824, or 920 described above. The monochromatic light emitters may include light emitters that may emit red, green, and blue light. The light emitters may include discrete light emitters on individual semiconductor dies, or may include arrays of light emitters, such as multi-ridge waveguide lasers, where each array of light emitters may be on a same semiconductor die. In the illustrated example, the light emitters may be grouped, where each group 1030 may include a red light emitter 1032, a green light emitter 1034, and a blue light emitter 1036 bonded on a substrate. Each group 1030 may have a width about a few millimeters (e.g., 0.5-2 mm) or smaller and a length about a few millimeters (e.g., 1-2 mm) or smaller. Light emitted by red light emitter 1032, green light emitter 1034, and blue light emitter 1036 in each group 1030 may be coupled into input waveguides 1020 and may be combined by, for example, coupling into a single output waveguide 1040 using directional couplers, such as evanescent waveguide couplers. The combined light may have a certain visible color and intensity, depending on the relative intensities of the red light, green light, and blue light that are combined. Therefore, the light emitted at the end of each output waveguide 1040 may have a desired color and intensity (or brightness) that are determined by the intensities of the red light, green light, and blue light that are coupled into the output waveguide. In this way, light emitted by the light emitters in each group 1030 may be coupled into input waveguides 1020 in PIC 1010 and then coupled into a respective output waveguide 1040 to combine into a color pixel having a certain color and a certain intensity (or brightness).

Light from the light emitters may be coupled into input waveguide 1020 by, for example, free space coupling using micro-optics, direct edge coupling, grating couplers, or other techniques. In some examples, an integrated waveguide coupler may be formed at the input end of each waveguide, where the waveguide core may be tapered to convert the light mode of the laser beam to match the light mode of the waveguide. FIG. 10 shows some examples of techniques for coupling light from lasers into input waveguides 1020. In one example, each group 1030-1 of light emitters may be mounted on a substrate and then integrated with PIC 1010 using flip-chip techniques such that the light emitters may be directly coupled to input waveguides 1020 without using a lens or having an air gap between the light emitters and PIC 1010. In another example, each group 1030-2 of light emitters may be mounted on a substrate and optically coupled to PIC 1010 through free-space optical coupling using, for example, micro-lenses mounted in the same substrate. In yet another example, light emitters in each group 1030-3 of light emitters may be individually aligned with and coupled to an input waveguide 1020 on PIC 1010 through free-space optical coupling either directly or using, for example, a micro-lens. In some examples, the light emitters or groups of light emitters may be aligned with input waveguides 1020 using active alignment, where the positions of the light emitters and/or lenses with respect to PIC 1010 may be adjusted during the assembly process to achieve the best coupling efficiency, for example, based on the measured power of the light coupled into the waveguides.

As described above, in some examples, light coupled into input waveguides 1020 may be split by waveguide beam splitters (not shown in FIG. 10), where a small fraction (e.g., about 1%) of the light coupled into each input waveguide 1020 may be coupled into another waveguide and be guided towards a photodetector (not shown in FIG. 10) that may measure the power of the light. The measured power of the light may be used to estimate the total power of the light coupled into each input waveguide 1020. For example, as described above with respect to FIG. 7, the measured light power may be processed by digital circuits 722 and used for controlling analog circuits 724 to adjust the driving currents for the light emitters, so that the light in each input waveguide 1020 may have a desired intensity to form a color pixel with a desired color and brightness. Even though not shown in FIG. 10, in some examples, light engine 1000 may include a light emitter configured to emit eye-tracking light that is invisible to human eyes (e.g., infrared light), a waveguide for guiding the eye-tracking light to the user's eye, a waveguide for guiding the eye-tracking light reflected by the user's eye to a photosensor, as described above with respect to FIG. 9.

Light engine 1000 may have a width about a few millimeters or tens of millimeters, and a length about a few millimeters or tens of millimeters, such that it may be suitable for use in head-mounted devices. The number of color pixels of light engine 1000 may depend on the dimension of light engine 1000 and the dimensions of the monochromatic light emitters. In some examples, light engine 1000 may include tens of groups of light emitter and tens of output waveguides to form tens of color pixels. In other examples, light engine 1000 may include more or fewer color pixels. Because of the small sizes of output waveguides 1040 and small distance between adjacent output waveguides 1040, the array of color pixels formed by the array of output waveguides 1040 can have a small pitch and thus a high resolution.

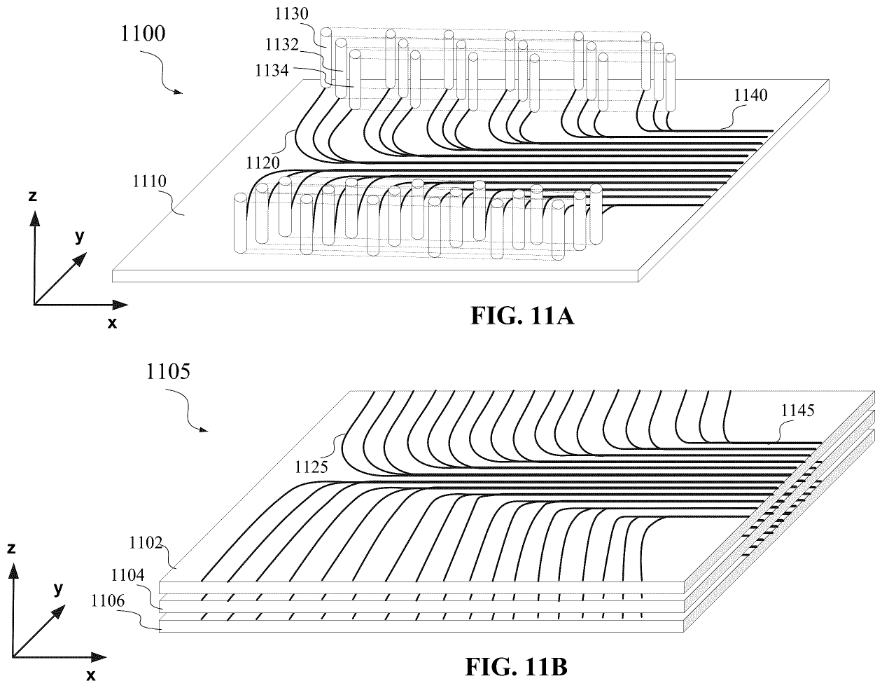

FIG. 11A illustrates an example of a light engine 1100 for a light beam scanning-based near-eye display system according to certain embodiments. In the illustrated example, light engine 1100 may include a substrate 1110 that includes a PIC formed thereon. The PIC may include waveguides such as input waveguides 1120, output waveguides 1140, and other waveguide components (e.g., waveguide splitters, directional couplers, combiners, etc.). The waveguides may be similar to waveguides described above with respect to FIGS. 7-10. Arrays of light emitters may be bonded to substrate 1110 and optically coupled to the PIC. In the illustrated example, the light emitters may be vertically coupled to substrate 1110, where the emitted light may be coupled into input waveguides 1120 by, for example, gratings or micro-prisms. The light emitters may include discrete light emitters, or arrays of light emitters on respective dies. In one example, a first die 1130 may include an array of monochromatic light emitters (e.g., red light emitting lasers), a second die 1132 may include an array of monochromatic light emitters (e.g., green light emitting lasers), and a third die 1134 may include an array of monochromatic light emitters (e.g., blue light emitting lasers), such that the light emitters in each array of monochromatic light emitters may be bonded to substrate 1110 and the PIC together. In this way, the number of alignment and bonding processes for integrating the light emitters with substrate 1110 and the PIC may be reduced.

FIG. 11B illustrates another example of a light engine 1105 for a light beam scanning-based near-eye display system according to certain embodiments. Light engine 1105 may include two or more light engines, such as light engines 1102, 1104, and 1106, in a stack. Each of light engines 1102, 1104, and 1106 may include a light engine 800, 900, or 1000 described above, and may include a plurality of monochromatic light emitters coupled to a PIC that includes input waveguides 1125, output waveguides 1145, and other waveguide-based components (e.g., splitter, combiner, directional couplers, etc.) formed thereon. Light engines 1102, 1104, and 1106 may be stacked to form a two-dimensional array of color pixels. In some examples, light engine 1102 and light engine 1104 may be bonded face-to-face. In some examples, the PICS of light engines 1102, 1104, and 1106 may be formed on a same substrate, where the PICS of light engines 1102, 1104, and 1106 may be on different waveguide layers on the substrate to form a two-dimensional array of color pixels. In some examples, light engine 1105 may include couplers for coupling light from one waveguide layer to another waveguide layer to form a two-dimensional array of color pixels.

Embodiments disclosed herein may be used to implement components of an artificial reality system or may be implemented in conjunction with an artificial reality system. Artificial reality is a form of reality that has been adjusted in some manner before presentation to a user, which may include, for example, a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including an HMD connected to a host computer system, a standalone HMD, a mobile device or computing system, or any other hardware platform capable of providing artificial reality content to one or more viewers.

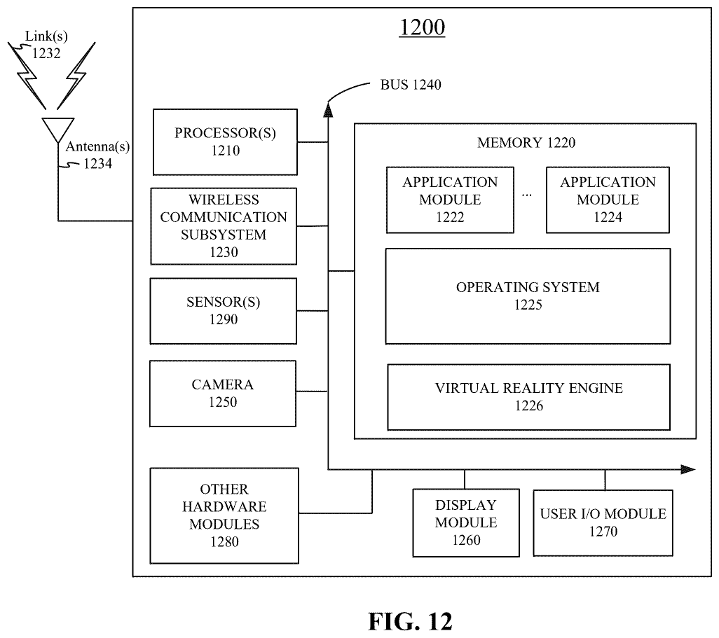

FIG. 12 is a simplified block diagram of an example electronic system 1200 of an example near-eye display (e.g., HMD device) for implementing some of the examples disclosed herein. Electronic system 1200 may be used as the electronic system of an HMD device or other near-eye displays described above. In this example, electronic system 1200 may include one or more processor(s) 1210 and a memory 1220. Processor(s) 1210 may be configured to execute instructions for performing operations at a number of components, and can be, for example, a general-purpose processor or microprocessor suitable for implementation within a portable electronic device. Processor(s) 1210 may be communicatively coupled with a plurality of components within electronic system 1200. To realize this communicative coupling, processor(s) 1210 may communicate with the other illustrated components across a bus 1240. Bus 1240 may be any subsystem adapted to transfer data within electronic system 1200. Bus 1240 may include a plurality of computer buses and additional circuitry to transfer data.

Memory 1220 may be coupled to processor(s) 1210. In some embodiments, memory 1220 may offer both short-term and long-term storage and may be divided into several units. Memory 1220 may be volatile, such as static random access memory (SRAM) and/or dynamic random access memory (DRAM) and/or non-volatile, such as read-only memory (ROM), flash memory, and the like. Furthermore, memory 1220 may include removable storage devices, such as secure digital (SD) cards. Memory 1220 may provide storage of computer-readable instructions, data structures, program modules, and other data for electronic system 1200.

In some embodiments, memory 1220 may store a plurality of application modules 1222 through 1224, which may include any number of applications. Examples of applications may include gaming applications, conferencing applications, video playback applications, or other suitable applications. The applications may include a depth sensing function or eye tracking function. Application modules 1222-1224 may include particular instructions to be executed by processor(s) 1210. In some embodiments, certain applications or parts of application modules 1222-1224 may be executable by other hardware modules 1280. In certain embodiments, memory 1220 may additionally include secure memory, which may include additional security controls to prevent copying or other unauthorized access to secure information.

In some embodiments, memory 1220 may include an operating system 1225 loaded therein. Operating system 1225 may be operable to initiate the execution of the instructions provided by application modules 1222-1224 and/or manage other hardware modules 1280 as well as interfaces with a wireless communication subsystem 1230 which may include one or more wireless transceivers. Operating system 1225 may be adapted to perform other operations across the components of electronic system 1200 including threading, resource management, data storage control and other similar functionality.

Wireless communication subsystem 1230 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 1200 may include one or more antennas 1234 for wireless communication as part of wireless communication subsystem 1230 or as a separate component coupled to any portion of the system. Depending on desired functionality, wireless communication subsystem 1230 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15×, or some other types of network. The techniques described herein may also be used for any combination of WWAN, WLAN, and/or WPAN.

Wireless communications subsystem 1230 may permit data to be exchanged with a network, other computer systems, and/or any other devices described herein. Wireless communication subsystem 1230 may include a means for transmitting or receiving data, such as identifiers of HMD devices, position data, a geographic map, a heat map, photos, or videos, using antenna(s) 1234 and wireless link(s) 1232.

Embodiments of electronic system 1200 may also include one or more sensors 1290. Sensor(s) 1290 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor.

Electronic system 1200 may include a display module 1260. Display module 1260 may be a near-eye display, and may graphically present information, such as images, videos, and various instructions, from electronic system 1200 to a user. Such information may be derived from one or more application modules 1222-1224, virtual reality engine 1226, one or more other hardware modules 1280, a combination thereof, or any other suitable means for resolving graphical content for the user (e.g., by operating system 1225). Display module 1260 may use LCD technology, LED technology (including, for example, OLED, ILED, μ-LED, AMOLED, TOLED, etc.), light emitting polymer display (LPD) technology, or some other display technology.

Electronic system 1200 may include a user input/output module 1270. User input/output module 1270 may allow a user to send action requests to electronic system 1200. An action request may be a request to perform a particular action. For example, an action request may be to start or end an application or to perform a particular action within the application. User input/output module 1270 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1200. In some embodiments, user input/output module 1270 may provide haptic feedback to the user in accordance with instructions received from electronic system 1200. For example, the haptic feedback may be provided when an action request is received or has been performed.

Electronic system 1200 may include a camera 1250 that may be used to take photos or videos of a user, for example, for tracking the user's eye position. Camera 1250 may also be used to take photos or videos of the environment, for example, for VR, AR, or MR applications. Camera 1250 may include, for example, a complementary metal-oxide-semiconductor (CMOS) image sensor with a few millions or tens of millions of pixels. In some implementations, camera 1250 may include two or more cameras that may be used to capture 3-D images.

In some embodiments, electronic system 1200 may include a plurality of other hardware modules 1280. Each of other hardware modules 1280 may be a physical module within electronic system 1200. While each of other hardware modules 1280 may be permanently configured as a structure, some of other hardware modules 1280 may be temporarily configured to perform specific functions or temporarily activated. Examples of other hardware modules 1280 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 1280 may be implemented in software.

In some embodiments, memory 1220 of electronic system 1200 may also store a virtual reality engine 1226. Virtual reality engine 1226 may execute applications within electronic system 1200 and receive position information, acceleration information, velocity information, predicted future positions, or any combination thereof of the HMD device from the various sensors. In some embodiments, the information received by virtual reality engine 1226 may be used for producing a signal (e.g., display instructions) to display module 1260. For example, if the received information indicates that the user has looked to the left, virtual reality engine 1226 may generate content for the HMD device that mirrors the user's movement in a virtual environment. Additionally, virtual reality engine 1226 may perform an action within an application in response to an action request received from user input/output module 1270 and provide feedback to the user. The provided feedback may be visual, audible, or haptic feedback. In some implementations, processor(s) 1210 may include one or more GPUs that may execute virtual reality engine 1226.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and/or C, such as AB, AC, BC, AA, ABC, AAB, AABBCCC, etc.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A light engine for near-eye display, the light engine comprising:
a first substrate;
a waveguide layer on the first substrate, the waveguide layer including a plurality of input waveguides and a plurality of output waveguides, wherein each group of three input waveguides of the plurality of input waveguides are coupled to a respective output waveguide of the plurality of output waveguides; and
a plurality of light emitters optically coupled to the first substrate, the plurality of light emitters including a first set of light emitters configured to emit light of a first color, a second set of light emitters configured to emit light of a second color, and a third set of light emitters configured to emit light of a third color,
wherein a first light emitter of the first set of light emitters is optically coupled to a first input waveguide of a group of three input waveguides, a second light emitter of the second set of light emitters is optically coupled to a second input waveguide of the group of three input waveguides, and a third light emitter of the third set of light emitters is optically coupled to a third input waveguide of the group of three input waveguides.

2. The light engine of claim 1, wherein a pitch of the plurality of output waveguides is less than 10 μm.

3. The light engine of claim 1, wherein the waveguide layer includes one or more waveguide directional couplers configured to couple each group of three input waveguides of the plurality of input waveguides to the respective output waveguide of the plurality of output waveguides.

4. The light engine of claim 1, further comprising micro-lenses configured to couple light emitted by the plurality of light emitters into the plurality of input waveguides.

5. The light engine of claim 1, wherein light emitted by the plurality of light emitters is optically coupled into the plurality of input waveguides by edge coupling or free-space optical coupling.

6. The light engine of claim 1, further comprising:
a plurality of photodetectors optically coupled to the first substrate; and
a plurality of beam splitters in the waveguide layer, each beam splitter of the plurality of beam splitters configured to couple a fraction of light guided by a respective input waveguide of the plurality of input waveguides out of the respective input waveguide towards a respective photodetector of the plurality of photodetectors.

7. The light engine of claim 1, further comprising:
a fourth light emitter configured to emit light that is invisible to human eyes; and
a first waveguide in the waveguide layer and optically coupled to the fourth light emitter, an output end of the first waveguide aligned with output ends of the plurality of output waveguides.

8. The light engine of claim 7, further comprising:
a fifth waveguide in the waveguide layer, an input end of the fifth waveguide aligned with the output ends of the plurality of output waveguides; and
a photosensor optically coupler to the fifth waveguide.

9. The light engine of claim 1, wherein the waveguide layer includes one or more waveguide core layers in a waveguide cladding layer.

10. The light engine of claim 9, wherein:
the one or more waveguide core layers include silicon nitride or aluminum oxide; and
the waveguide cladding layer includes silicon oxide.

11. The light engine of claim 1, wherein at least a subset of light emitters of the first set of light emitters is on a same semiconductor die.

12. The light engine of claim 1, wherein the first light emitter, the second light emitter, and the third light emitter are bonded to a second substrate, and the second substrate and the first substrate are bonded to a support structure.

13. A near-eye display comprising:
a light engine including an array of color pixels, each color pixel of the array of color pixels including:
a first input waveguide, a second input waveguide, a third input waveguide, and an output waveguide in a waveguide layer;
a first light emitter configured to emit light of a first color and optically coupled to the first input waveguide;
a second light emitter configured to emit light of a second color and optically coupled to the second input waveguide;
a third light emitter configured to emit light of a third color and optically coupled to the third input waveguide; and
one or more waveguide couplers configured to couple light from the first input waveguide, the second input waveguide, and the third input waveguide into the output waveguide;
a scanner configured to scan light emitted by the light engine; and
display optics configured to direct the light emitted by the light engine and scanned by the scanner to an eye of a user.

14. The near-eye display of claim 13, wherein a pitch of the array of color pixels is less than 10 μm.

15. The near-eye display of claim 13, further comprising:
a plurality of photodetectors; and
a plurality of beam splitters in the waveguide layer, each beam splitter of the plurality of beam splitters configured to couple a fraction of light guided by a respective input waveguide out of the respective input waveguide towards a respective photodetector of the plurality of photodetectors.

16. The near-eye display of claim 13, further comprising:
a fourth light emitter configured to emit light that is invisible to human eyes; and
a first waveguide in the waveguide layer and optically coupled to the fourth light emitter, the first waveguide configured to guide the light emitted by the fourth light emitter towards the scanner.

17. The near-eye display of claim 16, further comprising:
a fifth waveguide in the waveguide layer, an input end of the fifth waveguide configured to receive a portion of the light that is invisible to human eyes and is reflected by the eye of the user; and
a photosensor optically coupled to the fifth waveguide.

18. The near-eye display of claim 13, wherein:
the first light emitter, the second light emitter, and the third light emitter are bonded to a first substrate;
the waveguide layer is on a second substrate; and
the first substrate and the second substrate are on a support structure.

19. The near-eye display of claim 18, further comprising one or more electrical integrated circuit dies on the support structure, the one or more electrical integrated circuit dies including driving circuits for driving the first light emitters, the second light emitters, and the third light emitters of the array of color pixels.

20. A light engine for near-eye display, the light engine including an array of color pixels, each color pixel of the array of color pixels including:
a first input waveguide, a second input waveguide, a third input waveguide, and an output waveguide in a waveguide layer;
a first light emitter configured to emit light of a first color and optically coupled to the first input waveguide;
a second light emitter configured to emit light of a second color and optically coupled to the second input waveguide;
a third light emitter configured to emit light of a third color and optically coupled to the third input waveguide; and
one or more waveguide couplers configured to couple light from the first input waveguide, the second input waveguide, and the third input waveguide into the output waveguide.
